(19) United States
(12) Patent Application Publication
(10) Pub. No.: US 2026/0093960 A1
(43) Pub. Date: Apr. 2, 2026

(54) LARGE LANGUAGE MODEL INFERENCING ACCELERATION TECHNIQUES

(71) Applicant: ADVANCED MICRO DEVICES, INC., Santa Clara, CA (US)

(72) Inventors: Yao Cui Fehlis, New Braunfels, TX (US); Jalal Uddin Mahmud, San Jose, CA (US)

(21) Appl. No.: 18/901,142

(22) Filed: Sep. 30, 2024

(51) Int. Cl. G06N 3/047; G06F 40/284; G06N 3/092

(52) U.S. Cl. CPC G06N 3/047; G06F 40/284; G06N 3/092

(57) ABSTRACT

A method includes generating a plurality of tokens from a prompt to a large language model (LLM). The method includes, in one or more iterations, using a first neural network to output a set of speculative decoding parameters selected from a plurality of sets of speculative decoding parameters. Additionally, in the one or more iterations, the method includes performing speculative decoding using the set of speculative decoding parameters to generate a subsequent plurality of tokens appended to the plurality of tokens from on the prompt or from a previous iteration to generate an updated plurality of tokens and collecting a runtime of the speculative decoding. The one or more iterations are repeated until the updated plurality of tokens reaches a maximum token length. The first neural network is trained to output sets of speculative decoding parameters to minimize a sum of runtimes during the one or more iterations.

### BACKGROUND

Large language model (LLM) inferencing involves utilizing a pre-trained model to generate output text (e.g., responses to questions, text to complete a sentence, a summarization of text, etc.) based on input text (e.g., a question, an initial segment of a sentence, text to be summarized, etc.). The process of LLM inferencing includes generating tokens (small units of text) based on the input text and the LLM's vocabulary, passing the tokens through multiple layers of one or more neural networks for processing to generate output tokens, and decoding the output tokens into coherent output text. In some cases, the efficiency of LLM inferencing can be improved by optimizing speed and resource management to better handle real-time applications. For example, LLM inferencing can be accelerated by algorithmic techniques such as speculative decoding. Speculative decoding can save compute, memory, and power consumption without any loss in quality of the output of the LLM.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a processing system including an accelerated processing unit (APU) to tune parameters for speculative decoding at one or more compute units of a processing pipeline in accordance with some embodiments.

FIG. 2 shows an example diagram of a portion of the processing system of FIG. 1 including components within the APU in accordance with some embodiments.

FIG. 3 shows an example of a speculative decoding architecture implemented by the APU of FIGS. 1 and 2 in accordance with some embodiments.

FIG. 4 shows an example diagram illustrating an online reinforcement learning approach that is implemented by the APU of FIGS. 1 and 2 in accordance with some embodiments.

FIG. 5 shows an example of an Action space employed by the speculative decoding online reinforcement learning techniques in accordance with some embodiments.

FIG. 6 shows an example of a speculative decoding reinforcement learning agent employing multiple neural networks in accordance with some embodiments.

FIG. 7 shows an example of a speculative decoding (SD) method utilizing the reinforcement learning training techniques in accordance with some embodiments.

FIG. 8 shows an example of a neural network that is employed by an APU, such as the APU 105 of FIGS. 1 and 2, to select the SD parameters in accordance with some embodiments.

FIG. 9 shows an example of a flow chart illustrating a method for an APU, such as the APU of FIGS. 1 and 2, to perform speculative decoding with online reinforcement learning to automatically tune one or more speculative decoding parameters in accordance with some embodiments.

### DETAILED DESCRIPTION

Conventional LLM inferencing generates text from a single language model by utilizing autoregressive sampling which includes generating X tokens (where X is a positive integer) in X serial runs of the model. That is, conventional LLM inferencing employs one language model that generates one token per pass. For example, based on an input prompt of “The dog”, the conventional LLM inferencing model generates a first token “is” in a first pass to output “The dog is”, a second token “sleeping” in a second pass to output “The dog is sleeping”, a third token “on” in a third pass to output “The dog is sleeping on”, and so on until the final output of “The dog is sleeping on the floor” is generated. Using LLM to perform autoregressive sampling in this manner is slow since generating a single token requires a complete run throughout the LLM, which in some cases may include billions (e.g., 10 billion (B), 100 B, or more) of parameters.

Speculative decoding, on the other hand, runs two LLMs in parallel to speed up LLM inferencing: a large, comprehensive LLM to be employed to generate the final output text (referred to herein as the “target model”) and a second, smaller LLM (referred to herein as the “draft model”) that runs in parallel with the target model. The smaller draft model, in some cases, is orders of magnitude smaller than the target model and generates multiple look ahead (or “speculative”) tokens over multiple passes quicker than the target model is able to generate one token. Thus, the draft model is employed to “predict” a plurality of look ahead tokens and send the look ahead tokens to the target model. The target model then checks the looks ahead tokens from the draft model in parallel in a single pass while producing an additional token itself. In this manner, speculative decoding leverages the way transformer LLMs work since, even though LLMs can generate one token (e.g., a word, a punctuation mark, etc.) at a time (i.e., in a single pass), LLMs can check multiple tokens at once (i.e., in parallel) while generating a token in the same pass.

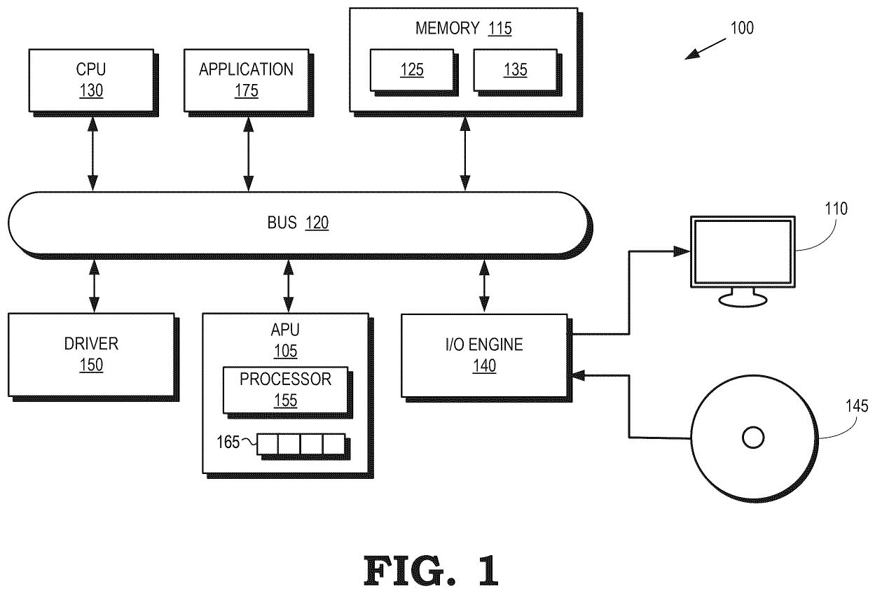

Speculative decoding thus employs the faster, but smaller, draft model in parallel with the more comprehensive, but slower, target model to speed up LLM inferencing without sacrificing accuracy. For example, the draft model can quickly generate 5 look ahead tokens in response to an initial prompt (e.g., a question) which are then checked by the target model while the target model also generates a token in the same single pass. If one or more of the look ahead tokens from the draft model are accepted by the target model, then at least one additional token is generated by speculative decoding per pass on the target model compared to if speculative decoding is not used (i.e., if the draft model is not used and only the target model is used). In this manner, speculative decoding can speed up LLM inferencing by 2× or more without degrading the quality of the LLM output. However, the acceleration benefits of speculative decoding are dependent on several speculative decoding parameters such as selecting the appropriate look ahead token length and selecting a suitable draft model to pair with the target model. In some cases, using un-optimized speculative decoding parameters may even slow down the LLM inferencing process. Conventional techniques typically rely on human intervention to implement a trial-and-error based approach to find the optimal speculative decoding. The techniques described in FIGS. 1-9 provide an online reinforcement learning approach to automatically tune these parameters in real-time, thereby improving the inferencing speeds of speculative decoding on a case-by-case basis without human intervention.

To illustrate, in some embodiments, a method includes generating a plurality of tokens based on a prompt to an LLM. For example, the prompt may include a question to the LLM, an initial segment of text to be completed by the LLM, or the like. The method includes, in one or more iterations, utilizing a first neural network to output a set of speculative decoding parameters selected from a number of sets of speculative decoding parameters. The number of sets of speculative decoding parameters include, for example, different combinations of look ahead token lengths and draft models for speculative decoding. The method also includes, in the one or more iterations, performing speculative decoding using the set of speculative decoding parameters to generate a subsequent plurality of tokens appended to the plurality of tokens based on the prompt or from a previous iteration to generate an updated plurality of tokens. The method further includes collecting a runtime of the speculative decoding. The one or more iterations are repeated until the updated plurality of tokens reaches a predetermined maximum token length (e.g., a maximum output text character limit). The first neural network is trained to output sets of speculative decoding parameters to minimize the total amount of runtimes of the speculative decoding from the one or more iterations. For example, in some embodiments, the first neural network uses a reinforcement learning approach that seeks to minimize the speculative decoding runtime. By training the first neural network to output sets of speculative decoding parameters that minimize the total runtime of the speculative decoding, the techniques described herein improve the speculative decoding speed, thereby reducing the LLM inferencing time.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components (e.g., the components in the APU or other components associated with the techniques described herein) represent software instructions that are executed by hardware such as a digital signal processor (DSP), an application-specific integrated circuit (ASIC), a set of logic gates, a field programmable gate array (FPGA), a programmable logic device (PLD), a hardware accelerator, a graphics processing unit (GPU), a neural network (NN) accelerator, an artificial intelligence (AI) accelerator, or other type of hardcoded or programmable circuit.

FIG. 1 shows an example of a processing system 100 that includes an accelerated processing unit (APU) 105 with a processor 155 to tune parameters for speculative decoding at a processing pipeline 165 in accordance with some embodiments. For example, in some cases, the processing pipeline 165 of the APU 105 includes a plurality of compute units (CUs) or processor cores that are configured to independently execute instructions of a wavefront concurrently or in parallel. In some cases, the wavefronts are associated with compute operations such as machine learning operations. In other cases, the wavefronts are associated with graphics operations to render images intended for output to a display 110. The processing system 100 also includes a memory 115. Some embodiments of the memory 115 are implemented as a dynamic random access memory (DRAM). In other embodiments, the memory 115 is alternatively or additionally implemented using other types of memory including static random access memory (SRAM), nonvolatile RAM, and the like. In the illustrated embodiment, the APU 105 communicates with the memory 115 over a bus 120. However, some embodiments of the APU 105 communicate with the memory 115 over a direct connection or via other buses, bridges, switches, routers, and the like. The APU 105 executes instructions stored in the memory 115 and the APU 105 stores information in the memory 115 such as the results of the executed instructions. For example, the memory 115 can store a copy 125 of instructions from a program code that is to be executed by the APU 105.

The processing system 100 is generally configured to execute sets of instructions (e.g., computer programs) such as an application 175 to conduct specified tasks for an electronic device. Examples of such tasks include controlling aspects of the operation of the electronic device, performing computations associated with machine learning or databasing applications, displaying information to a user to provide a specified user experience, communicating with other electronic devices, and the like. Accordingly, in different embodiments the processing system 100 is employed in one of a number of types of electronic device, such as a desktop computer, laptop computer, server, game console, tablet, smartphone, and the like. In some cases, the processing system 100 may include more or fewer components than illustrated in FIG. 1. For example, the processing system 100 may additionally include one or more input interfaces, non-volatile storage, one or more output interfaces, network interfaces, and one or more displays or display interfaces.

The processing system 100 includes a central processing unit (CPU) 130 for executing instructions. Some embodiments of the CPU 130 include multiple processor cores (not shown in the interest of clarity) that independently execute instructions concurrently or in parallel. The CPU 130 is also connected to the bus 120 and therefore communicates with the APU 105 and the memory 115 via the bus 120. The CPU 130 executes instructions such as program code 135 stored in the memory 115 and the CPU 130 stores information in the memory 115 such as the results of the executed instructions. The CPU 130 is also able to initiate graphics processing by issuing draw calls to the APU 105 or initiate machine learning operations by issued corresponding commands to the APU 105. A draw call is a command that is generated by the CPU 130 and transmitted to the APU 105 to instruct the APU 105 to render an object in a frame (or a portion of an object). Some embodiments of a draw call include information defining textures, states, shaders, rendering objects, buffers, and the like that are used by the APU 105 to render the object or portion thereof. The APU 105 renders the object to produce values of pixels that are provided to the display 110, which uses the pixel values to display an image that represents the rendered object.

An input/output (I/O) engine 140 handles input or output operations associated with the display 110, as well as other elements of the processing system 100 such as keyboards, mice, printers, external disks, and the like. The I/O engine 140 is coupled to the bus 120 so that the I/O engine 140 communicates with the APU 105, the memory 115, or the CPU 130. In the illustrated embodiment, the I/O engine 140 is configured to read information stored on an external storage medium 145. The external storage medium 145 stores information representative of program code used to implement an application such as a video game. The program code on the external storage medium 145 can be written to the memory 115 to form the copy 125 of instructions that are to be executed by the APU 105 or the CPU 130.

The driver 150 is a computer program that enables a higher-level computing program, such as from the application 175, to interact with the APU 105. For example, the driver 150 translates standard code received from the application 175 into a native format command stream understood by the APU 105. The driver 150 allows input from the application 175 to direct settings of the APU 105. Such settings include selection of a render mode, an anti-aliasing control, a texture filter control, a batch binning control, and deferred pixel shading control, for example. In some embodiments, the performance of the APU 105 is enhanced by the driver 150 choosing the appropriate mode or setting for the APU 105 to operate based on the instructions issued by the application 175 running on the CPU 130. In some cases, the driver 150 is updated via a software or firmware update to improve the performance, stability, and compatibility of the APU 105 with the various other components of the processing system 100.

In some embodiments, the APU 105 has a processing pipeline 165 that includes highly parallel processing capabilities to execute the workloads issued to it by the CPU 130 or the driver 150. For example, in the case of executing graphics operations, the processing pipeline 165 is a graphics pipeline that includes multiple stages configured for concurrent processing of different primitives in response to a draw call. Stages of the graphics pipeline in the APU 105 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene. The shaders that are implemented in the graphics pipeline state are represented by corresponding byte codes. In some cases, the information representing the graphics pipeline state is hashed or compressed to provide a more efficient representation of the graphics pipeline state. In other cases, the processing pipeline 165 is a compute processing pipeline configured to execute machine learning or neural network type operations. For example, the processing pipeline 165 is configured to implement a convolutional neural network (CNN) that receives input data at an input layer of the CNN, performs convolution operations on the input data to generate convolved data at one or more hidden layers of the CNN, and generates an output based on the convolved data via an output layer of the CNN.

In some embodiments, the APU 105 is configured to execute LLM inferencing to generate text based on an initial prompt. The processor 155 of the APU 105 receives an LLM prompt (or prompt for brevity) from the CPU 130 or the application 175 and generates an output based on the prompt. For example, the prompt may include a question, an initial segment of text to be completed, a block of text to be summarized, or the like. The processor 155 passes the generated plurality of tokens to the processing pipeline 165, which processes the tokens through multiple layers of one or more neural networks to generate output tokens. The processing pipeline 165 then decodes the output tokens into output text.

In some cases, the APU 105 is configured to accelerate LLM inferencing by executing an algorithmic technique. One example of such an algorithmic technique is speculative decoding. To execute speculative decoding, the processing pipeline 165 employs a draft model in parallel with a target model. The draft model employs an autoregressive model to generate a sequence of look ahead tokens in response to receiving the prompt and feeds the sequence of look ahead tokens to the target model. The target model employs a non-autoregressive model that checks the validity of each of the tokens in the sequence of look ahead tokens generated by the draft model in parallel. In addition, the target model generates an additional token that the target model appends to the last accepted look ahead token (if any) from the draft model. That is, the target model checks the validity of the predictions (the look ahead tokens) from the draft model (i.e., the target model determines whether to accept one or more of the look ahead tokens based on the look ahead tokens satisfying a predetermined criteria) and generates the additional token in a single pass. In some embodiments, the draft model is a factor of magnitude smaller than the target model, e.g., the draft model employs N (where N is a positive integer) parameters and the target model employs 10*N parameters. If the target model rejects all the look ahead tokens from the draft model (e.g., if the look ahead tokens do not satisfy one or more predetermined criteria of a rejection sampling model), then the target model appends the additional token it generates to the tokens generated from the prompt or from the last round of speculative decoding. That is, even if the target model rejects all of the look ahead tokens from the draft model, the target model still generates a token from the single pass that it otherwise would have generated even if draft model would not have been used.

To accelerate speculative decoding according to the techniques described herein, in some embodiments, the processing pipeline 165 employs an online reinforcement training approach. For example, in one or more iterations, the processing pipeline 165 utilizes a first neural network to output a set of LLM parameters selected from a number of sets of LLM parameters. In some cases, the sets of LLM parameters include different combinations of look ahead token lengths and draft models to pair with the target model for speculative decoding. The processing pipeline 165, in one or more iterations, performs speculative decoding using the set of LLM parameters to generate a subsequent plurality of tokens appended to the plurality of tokens based on the prompt or from a previous iteration to generate an updated plurality of tokens. The APU 105 (e.g., via the processor 155) collects a runtime of the speculative decoding in each of the one or more iterations. The “runtime” refers to the time that it takes to perform the speculative decoding in each iteration. In addition, the “total runtime,” “sum of runtimes,” or the like refers to total runtime of multiple iterations of speculative decoding. The processing pipeline 165 repeats the iterations until the updated plurality of tokens reaches a predetermined maximum token length (e.g., a maximum output text character limit) and outputs text based on the most recent updated plurality of tokens. Furthermore, the APU 105 is configured to train the first neural network to output sets of LLM parameters to minimize the total amount of runtimes of the speculative decoding from the one or more iterations. In some embodiments, the first neural network is trained using a reinforcement learning approach that seeks to minimize the speculative decoding runtime. By training the first neural network to output sets of LLM parameters that minimize the total runtime of the speculative decoding, the APU1 105 improves the speculative decoding speed, thereby reducing the LLM inferencing time.

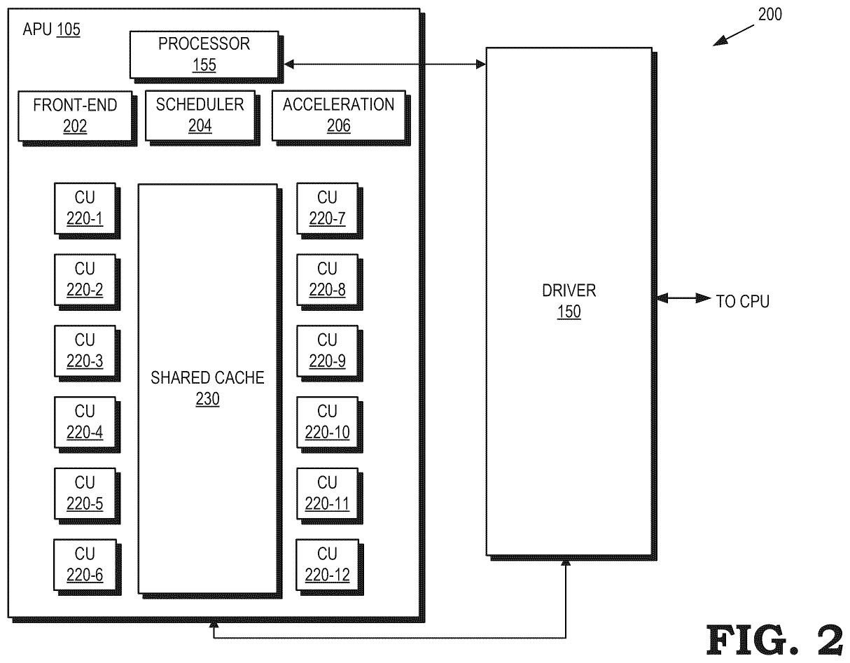

FIG. 2 shows an example diagram of a portion 200 of the processing system 100 of FIG. 1 in accordance with some embodiments. In the illustrated embodiment, the portion 200 of the processing system includes the driver 150 and the APU 105 that is configured to execute workloads for one or more applications, such as the application 175 of FIG. 1, running on a processing system, such as the processing system 100 of FIG. 1. In some embodiments, the applications include one or more of a compute application, a graphics application, or a combination thereof that issues respective sets of instructions (or threads) to a CPU, such as CPU 130 of FIG. 1, which then communicates the instructions to the APU 105 via the driver 150.

In the illustrated embodiment, the APU 105 includes the aforementioned processor 155 that is configured to receive a command stream (e.g., a prompt to an LLM implemented at one or more components of the APU 105), from a CPU via the driver 150, indicating one or more workgroups to be executed at the APU 105. After receiving the command stream, the processor 155 parses the command stream and issues respective instructions of the indicated workgroups to a front-end circuitry 202, a scheduling circuitry 204), or both. Based on the instructions of the workgroups received from the processor 155, the front-end circuitry 202, the scheduler circuitry 204, or both are configured to provide data indicating threads (e.g., operations) to be executed for these workgroups to a processing pipeline.

The APU 105 also includes a plurality of compute units (CUs) 220 configured to implement a processing pipeline, such as the processing pipeline 165 of FIG. 1. The scheduler circuitry 204, in one example, is configured to update one or more registers of one or more of the CUS 220 that is configured to execute a first group of waves of the workgroup. After the corresponding compute unit 220 has executed the first group of waves, scheduler circuitry 204 updates one or more registers of the compute unit 220 to schedule a second group of waves of the workgroup to be executed by the compute unit 220. To execute these waves, each compute unit is connected to a shared cache 230 that includes a volatile memory, non-volatile memory, or a combination thereof accessible by one or more compute units 220. The shared cache 230, for example, is configured to store data (e.g., register files, values, operands, instructions, variables) used in the execution of one or more waves, data resulting from the performance of one or more waves, or both. Because the shared cache 230 is accessible by multiple ones of the compute units 220, a first compute unit, e.g., compute unit 220-1, is enabled to provide results from the execution of a first wave to a second compute unit, e.g., compute unit 220-2, executing a second wave. Though the example embodiment presented in FIG. 2 shows the APU 105 as including 12 CUs (220-1 to 220-12), in other implementations, the APU 105 can include another number of compute units 220, e.g., 16, 32, or another number of compute units.

Additionally, in the illustrated embodiment, to help perform instructions for one or more workgroups, the APU 105 includes an acceleration circuitry 206. Such acceleration circuitry 206 includes hardware (e.g., fixed-function hardware) configured to execute one or more instructions for one or more workgroups. As an example, the acceleration circuitry 206 includes one or more instances of fixed function hardware configured to encode frames, encode audio, decode frames, decode audio, display frames, output audio, perform matrix multiplication, or any combination thereof. To schedule instructions for execution on such hardware, the scheduler circuitry 204 is configured to update one or more physical registers (not shown for clarity purposes) of the acceleration circuitry 206.

In some embodiments, the APU 105 is configured to execute speculative decoding techniques to accelerate LLM inferencing. That is, the APU 105, via a combination of the processor 155, the front-end circuitry 202, the scheduler 204, the acceleration circuitry 206, and one or more of the compute units 220, performs the reinforcement techniques described herein to auto-tune speculative decoding parameters in real-time to achieve faster rates of speculative decoding, thereby increasing the speed of the LLM inferencing model implemented by the APU 105. For example, the APU 105 is configured to implement a first neural network at the acceleration circuitry 206 and/or at one or more of the compute units 220 to output sets of LLM parameters. The LLM parameters, in some cases, include one or more of a look ahead token length and a draft model to pair with a target model in speculative decoding. The draft model is selected from a plurality of models from the same model family as the target model. For example, the plurality draft models are differently sized model options (e.g., 125 million (M) parameters, 350M, 1 billion (B) parameters, 3B, or the like) that are smaller than the larger target model (e.g., 10B, 50B, 100 B, or another number of parameters). The look ahead token length (K) is an integer value that is smaller than the number of total output tokens of the LLM model. The first neural network is trained to output the sets of LLM parameters that minimize the total amount of runtime from one or more iterations of speculative decoding.

FIG. 3 shows an example of a speculative decoding architecture 300, which is implemented by the APU 105 of FIGS. 1 and 2, in accordance with some embodiments. The speculative decoding architecture 300 runs a target model 330 and a draft model 310 in parallel to improve LLM inferencing speeds without reducing accuracy. In some embodiments, the techniques described herein employ one or more neural networks that are trained to select a particular set of speculative decoding LLM parameters (e.g., look ahead token length, draft model, hardware configuration such as a particular number of compute units such as compute units 220 of FIG. 2, etc.) to speed up the LLM inferencing time.

The speculative decoding architecture 300 shows an iteration of speculative decoding according to some aspects which utilizes the target model 330 and the draft model 310 to accelerate LLM inferencing. The smaller draft model 310 predicts a number (K, where K is a positive integer) of look ahead tokens (in this example, K=4) over multiple passes through the draft model 310, then the target model 330 confirms the look ahead tokens from the draft model 310 while generating a token of its own in a single pass. For example, in some embodiments, the draft model 310 generates a prediction probability (e.g., a value between 0 and 1) for each of its look ahead tokens, and the target model 330 compares the prediction probabilities from the draft model 310 with its own prediction probabilities while generating an addition token in the single pass. In some cases, if the prediction probabilities from the draft model 310 and the target model 330 satisfy one or more criteria (e.g., the prediction probability of the target model 330 is higher than that of the draft model 310), the target model 330 accepts the look ahead tokens. As such, the speculative decoding architecture 300 leverages the autoregressive nature of the draft model 310 to do sequential predictions based on the smaller nature (e.g., fewer parameters) of the draft model 310 and then utilizes the larger target model 330 to verify the predictions of draft model 310 while generating a token of its own in a single pass.

Referring to the embodiment illustrated in FIG. 3, the speculative decoding architecture 300 receives one or more initial tokens, P, based on a prompt. For example, the prompt is the question “What is the big dog doing?” The one or more initial tokens, P, are generated based on the prompt. Conventional LLMs employ a single, large LLM model to generate one token per pass, which is time consuming. The speculative decoding architecture 300 utilizes a smaller draft model 310 that is, in some cases, orders of magnitude smaller than the target model 330. For example, the draft model 310 is a LLM based on 1B parameters and the target model 330 is a LLM based on 100B parameters. The smaller draft model 310 generates one look ahead token per sequential pass (or iteration) through its smaller number of parameters and appends the look ahead token to the look ahead token from the previous pass (if any) up to K look ahead tokens.

In the illustrated example, the draft model 310 sequentially generates K look ahead tokens in K passes, where K is 4. That is, in a first pass (or iteration) through its LLM, the draft model 310 generates a first token (“The”), then a second token (“big”) in a second iteration, then a third token (“dog”) in a third iteration, and then a fourth token (“is”) in a fourth iteration. In some embodiments, the draft model 310 generates a draft model probability distribution for each of the look ahead tokens. The four look ahead tokens (“The big dog is”) are then input to the target model 330 along with the one or more initial tokens, P. The target model 330 confirms the four look ahead tokens from the draft model 310 by checking their respective draft model probability distribution with a target model probability distribution of the target model 330, and then generates a fifth token (“sleeping”) in a single pass through its larger LLM. Thus, the target model 330 leverages the parallel nature of LLMs to check the sequence of look ahead tokens generated by the draft model 310 and to generate an additional token (the fifth token in this example). Although not illustrated, in some cases, the target model 330 accepts fewer or none of the look ahead tokens generated by the draft model 310. In some embodiments, the target model 330 accepts or rejects the look ahead tokens generated by the draft model 310 based on a rejection sampling model. For example, the rejection sampling model includes determining whether to accept or reject the first look ahead token of the look ahead token sequence by comparing the target model probability distribution for the first look ahead token generated by the target model 330 to the draft model probability distribution for the first look ahead token generated by the draft model 310. If the target model probability distribution is greater than the draft model probability distribution, then the target model 330 accepts the first look ahead token and moves on to check the second look ahead token of the look ahead token sequence in a similar manner and so on. If the draft model probability distribution is greater than target model probability distribution, then the target model 330 rejects the first token (or whichever token is being checked) and stops checking the remaining look ahead tokens in the sequence. The target model 330 checks the look ahead tokens in parallel while generating a token of its own in a single pass. As such, even if only one look ahead token from the draft model (i.e., the first token, “The”) is accepted by the target model 330, the speculative decoding architecture 300 potentially provides at least some level of speed up compared to utilizing the target model 330 by itself.

In some cases, the speed up of the speculative decoding architecture 300 is represented by the following equation:

$$\begin{matrix}speedup = \frac{time complexity of autoregressive model}{time complexity of speculative model} \\ = \frac{N * {t}_{target}}{\frac{N}{r ( K + 1 )} * ( {t}_{draft} K + {t}_{target} )} \\ = \frac{r ( K + 1 ) * {t}_{target}}{{t}_{draft} K + {t}_{target}}\end{matrix}$$

where r is the average acceptance rate of the draft model 310 by the target model 330, K is the look ahead token length (in the illustrated embodiment, K=4), t_{draft} is the runtime of the draft model 310, and t_{target} is the runtime of the target model 330.

Since the acceptance rate, r, can vary on a case-by-case basis, it is difficult to determine the optimal parameters to speed up speculative decoding ahead of time. However, the techniques disclosed herein employ an online reinforcement learning mechanism to select one or more speculative decoding parameters to maximize the potential speedup. For example, in some embodiments, an APU, such as APU 105 of FIGS. 1 and 2, utilizes online reinforcement learning to select a look ahead token length (K) and a draft model to pair with the target model that minimize the total speculative decoding runtime, thereby improving the speed of LLM inferencing.

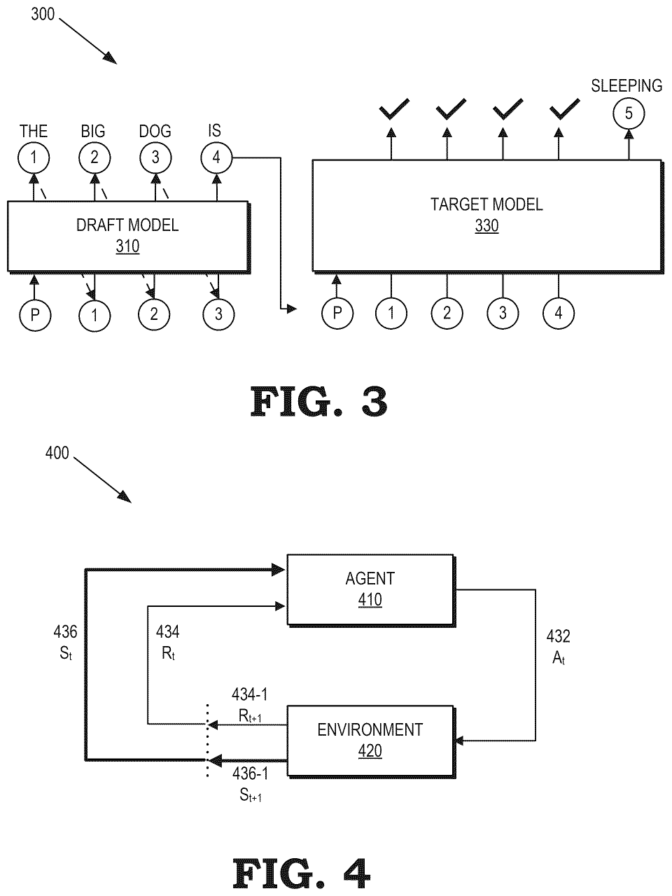

FIG. 4 shows an example diagram 400 illustrating an online reinforcement learning approach that is implemented by an APU such as the APU 105 of FIGS. 1 and 2, in accordance with some embodiments. Reinforcement learning is a machine learning technique that enables an agent to learn in an interactive environment by trial and error using feedback from the environment based on the agent's own actions and experiences.

In the reinforcement learning framework illustrated in diagram 400, the agent 410 learns to interact with the environment 420. Initially, the agent 410 does not know which action (A) to take, and the agent 410 starts by taking a random action (A₀) and collecting rewards (Rₜ) 434 based on a corresponding state (Sₜ) 436. The agent 410 then takes another action (Aₜ) in a next attempt and collects rewards (Rₜ₊₁) 434-1 based on a corresponding state (Sₜ₊₁) 436-1 of the next attempt in the environment 420, and so on. Over time, the agent 410 learns the rules or policies of taking actions in the environment 420 to maximize the rewards (R). In some cases, the agent 410 implements and/or stores the rules and policies using a look up table or a neural network.

Since the acceptance rate, r, (i.e., the rate of the look ahead tokens generated by the draft model 310 that are accepted by the target model 330) varies on a case-by-case basis, the optimal speculative decoding parameters to maximize the speedup (the “reward”) are difficult to determine ahead of time. However, the techniques described herein utilize an online reinforcement technique such as the one shown in FIG. 4 to change speculative decoding parameters to maximize the reward, which in this case is analogous to minimizing the runtime. For example, in some embodiments, the speculative decoding parameters include one or more of the draft model that is selected to pair with the target model and the look ahead token length (K). In some embodiments, the draft model 310 shares the same tokenizer (or vocabulary set) as the target model 330, albeit at a reduced size. In some cases, the draft model 310 and the target model 330 belong to the same LLM family. In some embodiments, the techniques described herein include storing (e.g., in a memory) a list of available models (referred to herein as “a plurality of differently sized models of a common model family”) from which to select. In addition, in some embodiments, the look ahead token length (K) is limited to be a positive integer that is less than or equal to the number of total output tokens of the LLM.

In some embodiments, the techniques described herein formulate the online reinforcement learning approach based on one or more of the following features. The states (e.g., states, S, 436 of FIG. 4) are set to be the prompt in the first reinforcement learning iteration, and then set to be the prompt plus the added tokens in every iteration of the speculative decoding. The actions (e.g., actions, A, 432) of FIG. 4) are the possible combinations of the different speculative coding parameters. For example, in some embodiments, the possible combinations are based on combinations of a draft model size and a look ahead token length. The reward (e.g., rewards, R, 434 of FIG. 4) is based on the total runtime (TR). For example, the reward is set to be a negative multiple (e.g., −1*TR) or to be inversely proportional (e.g., 1/TR) of the total runtime. The techniques described herein train a reinforcement learning agent (e.g., such as the agent 410 of FIG. 4) through repeated iterations (also referred to as “episodes”) including sequences of states, actions, and rewards to learn which actions maximize the cumulative reward (i.e., which combinations of speculative decoding parameters minimize the total runtime).

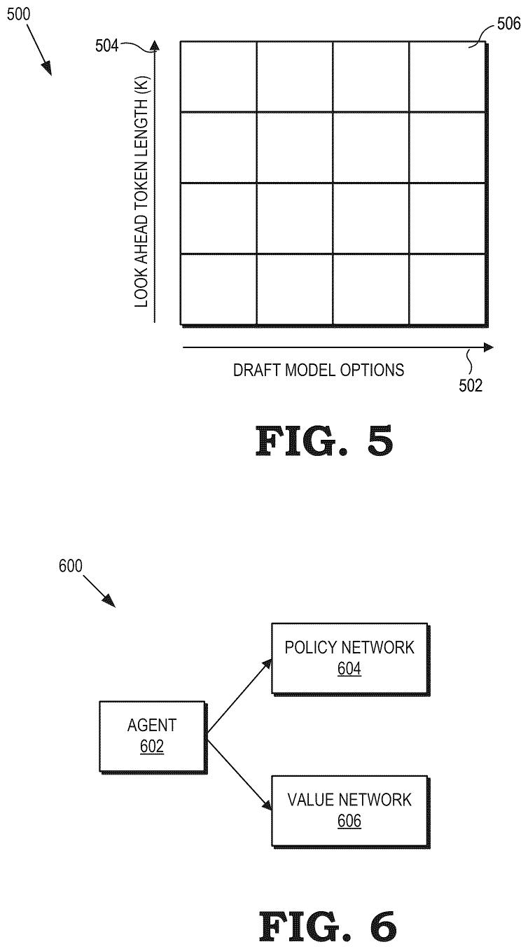

FIG. 5 shows an example of an action space 500 employed by the speculative decoding online reinforcement learning techniques in accordance with some embodiments. The action space 500 shows different combinations 506 (one such combination labeled for clarity purposes) of two different speculative decoding parameters. In the illustrated embodiment, the draft models are arranged along the x-axis 502 of the action space 500, and the different look ahead token length (K) values are arranged along the y-axis 504 of the action space 500. For example, if the target model is a large Open Pre-trained Transformer (OPT) model including 13B, 30B, 66B, or 175B parameters, the draft models along the x-axis can include a 125M OPT parameter model, a 350M OPT parameter model, a 1.3B OPT parameter model, and a 2.7B parameter model. That is, in some embodiments, the draft model and target model are both selected from a common LLM family such as the OPT LLM family or the like. As another example, in some embodiments, the look ahead token length (K) values along the y-axis range from K=1 to K=50.

In some embodiments, an APU such as the APU 105 of FIGS. 1 and 2 is configured to employ a first neural network to select one combination 506 of speculative decoding parameters from the action space 500 to utilize in an iteration of speculative decoding. That is, in some cases, the speculative decoding parameters that form the action space (e.g., the different draft models and the look ahead token lengths) are stored at a memory and the APU 105 is configured to retrieve or fetch a combination of the speculative decoding parameters from the memory. In some embodiments, the APU generates a probability distribution defined by the different combinations of speculative decoding parameters and selects the set of speculative decoding parameters based on the probability distribution. For example, the APU is configured to select a 350M OPT parameter model and a look ahead token length (K) of 4, execute one or more iterations of speculative decoding based on the selected parameters, and collect a total runtime of the one or more iterations of the speculative decoding to determine a reward. In some embodiments, the techniques described herein utilize a policy network to determine which actions to take in the Action space and a value network to predict rewards for each speculative decoding iteration or episode.

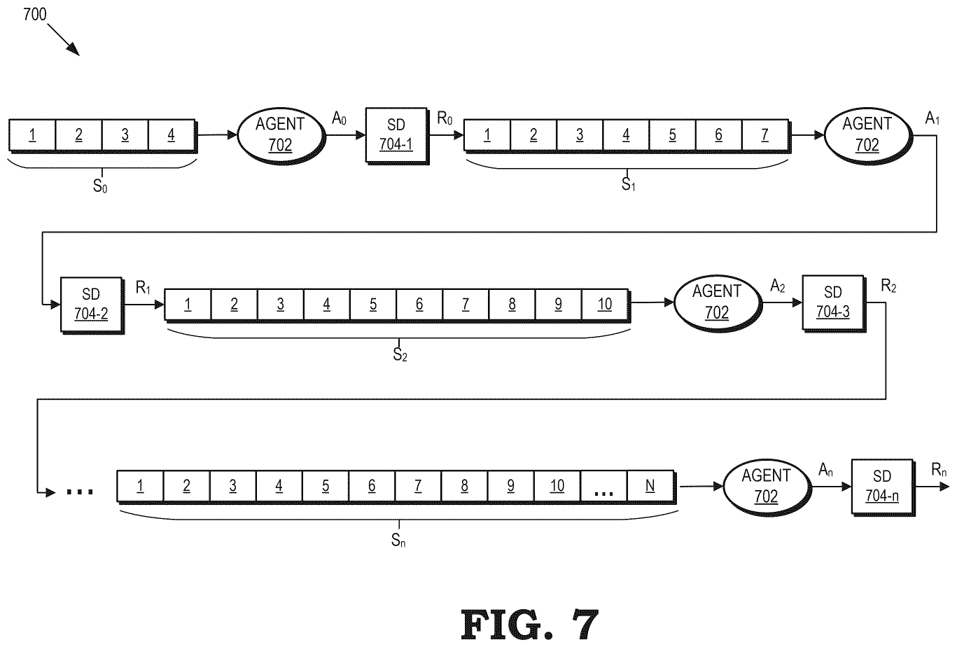

FIG. 6 shows an example of a speculative decoding reinforcement learning agent 602 using two networks in accordance with some embodiments. In some embodiments, speculative decoding reinforcement learning agent 602 is executed by one or more components of an APU, such as the CUs 220 or the acceleration circuitry 206 of the APU 105 of FIG. 2.

In the illustrated embodiment, the first network employed in the speculative decoding reinforcement learning agent 602 is the policy network 604. In some embodiments, the policy network 604 is a neural network that employs a probability distribution predictor to determine which action to take in an action space such as the Action space 500 of FIG. 5. That is, the policy network 604 selects one combination (also referred to as a “set”) of speculative decoding parameters of the plurality of combinations (or sets) of speculative decoding parameters in the action space based on which combination the policy network 604 determines to have the highest probability to maximize the reward. In some embodiments, the speculative decoding reinforcement learning agent 602 also employs a second network such as a value network 606. In some embodiments, the value network 606 predicts or determines the reward for each speculative decoding iteration or episode based on the speculative decoding parameters selected by the policy network 604.

FIG. 7 shows an example of a speculative decoding (SD) method utilizing the reinforcement learning training techniques 700 in accordance with some embodiments. In some embodiments, an APU, such as the APU 105 of FIGS. 1 and 2, executes the SD method utilizing the reinforcement learning training techniques 700.

In the illustrated embodiment, the SD method utilizing the reinforcement learning training techniques 700 starts with an initial state (S₀) in a new episode. The initial state (S₀) includes a first plurality of tokens (1-4). In some cases, the APU generates the first plurality of tokens (1-4) in the initial state (S₀) based on a received prompt. The first plurality of tokens (1-4) in the initial state (S₀) are passed to the agent 702. The agent 702, for example, corresponds to the agent 602 of FIG. 6 and includes two neural networks: a policy network corresponding to the policy network 604 of FIG. 6 and a value network corresponding to the value network 606 of FIG. 6. In some embodiments, the policy network of the agent 702 generates a probability distribution over an action space.

For example, the agent 702 generates the probability distribution over the action space 500 of FIG. 5. In some embodiments, the value network of the agent 702 outputs a value to generate a reward for this episode (i.e., iteration). The agent 702 outputs an action (A₀) based on probability distribution over an action space, where the action (A₀) includes one or more speculative decoding (SD) parameters. For example, in some cases the action (A₀) includes a particular combination of a look ahead token length (K) and a draft model size. Then, based SD parameters from the action (A₀), the APU performs a first iteration of speculative decoding (SD) 704-1 to generate a second plurality of tokens (5-7) that the APU appends to the first plurality of tokens (1-4). In the illustrated embodiment, the second plurality of tokens includes three tokens, but in other embodiments, another number of tokens is generated (e.g., any positive integer). During this process, the APU collects the SD runtime (R₀) of the first SD iteration 704-1. The first plurality of tokens (1-4) from the prompt and the second plurality of tokens (5-7) from the first iteration of SD decoding 704-1 then form the updated plurality of tokens in a new state (S₁). The APU passes the new state (S₁) to the agent 702, and the SD method utilizing the reinforcement learning training techniques is repeated until the updated plurality of tokens (N) of a subsequent state (Sₙ) reaches a maximum number of tokens. The total reward is based on the sum of the runtimes (e.g., R₀+R₁+ . . . +Rₙ). During the SD method utilizing the reinforcement learning training techniques 700, the neural networks employed by the agent 702 are trained to select the actions (e.g., the SD parameters) in order to minimize the sum of the runtimes.

Thus, by performing the SD method utilizing the reinforcement learning training techniques 700, the agent 702 implemented by the APU learns how to take actions (e.g., selecting SD parameters such as the look ahead token length or the draft model size) to minimize the sum of the runtimes.

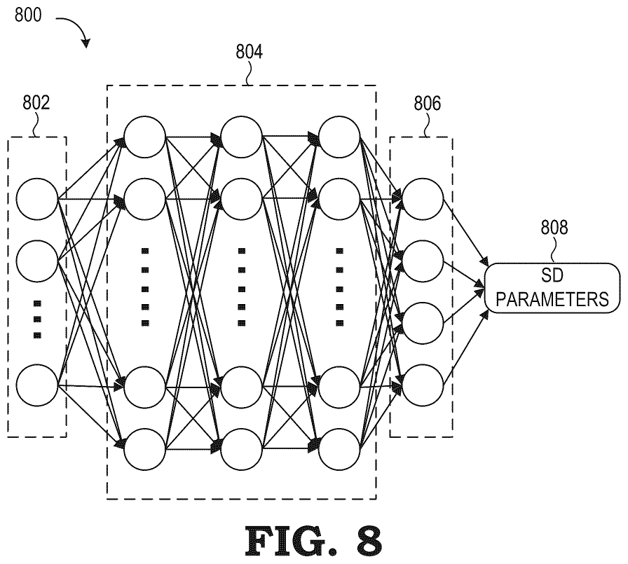

FIG. 8 shows an example of a neural network 800 that is employed by an APU, such as the APU 105 of FIGS. 1 and 2, to select the speculative decoding (SD) parameters in accordance with some embodiments. The neural network 800 includes an input layer 802 with a plurality of nodes. In some embodiments, the plurality of nodes in the input layer 802 corresponds to one or more of the speculative decoding parameters. For example, in some embodiments, the nodes in the input layer 802 correspond to different combinations of draft models and look ahead token lengths of the action space 500 of FIG. 5. The neural network 800 also includes one or more hidden layers 804. In the illustrated embodiments, three hidden layers 804 are shown. In other embodiments, the neural network 800 includes other numbers of hidden layers (e.g., two layers, four layers or more). Each of the one or more hidden layers 804 includes a plurality of nodes (e.g., 32, 64, 128, 256, 512, 1024, or another number of nodes) which is configured to receive signals from previous nodes and apply an activation function to the received signal to generate an output that is then input to one or more nodes at the next layer of the neural network 800. Thus, each output of each node (or “neuron”) in the hidden layers 804 of the neural network 800 is computed based on a non-linear function of the sum of its inputs and, in some cases, a weight value that can be adjusted as the neural network 800 is trained. The weight value increases or decreases the strength of the signal at the particular connection in the neural network 800. Eventually, the signals propagated through the neural network 800 reach an output layer 806 which gives the final result of the data processed by the neural network 800. For example, the output layer 806 outputs a set of SD parameters 808 to utilize in speculative decoding such as a particular draft model and a particular look ahead token length. In the illustrated embodiment, the output layer 806 includes four nodes. In other embodiments, other numbers of nodes are contemplated.

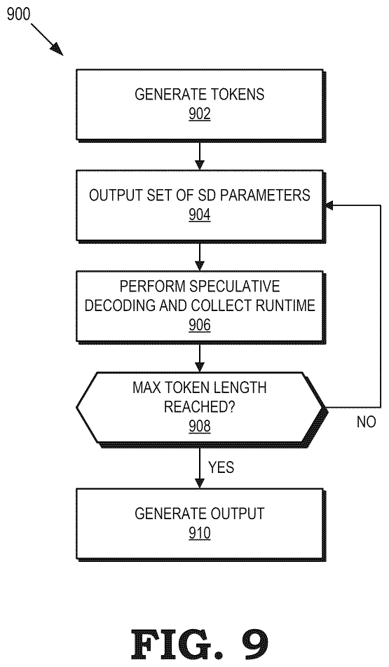

FIG. 9 shows an example of a flow chart 900 illustrating a method for an APU, such as the APU 105 of FIGS. 1 and 2, to perform speculative decoding with online reinforcement learning to automatically tune one or more speculative decoding parameters in accordance with some embodiments.

At block 902, the APU generates one or more initial tokens based on a prompt to an LLM implemented by the APU.

At block 904, the APU outputs a set of speculative decoding parameters selected from a plurality of sets of speculative decoding parameters. For example, in some embodiments, the set of speculative decoding parameters includes a combination of a draft model and a look ahead token length selected from a plurality of draft models and look ahead token lengths. In some embodiments, the set of speculative decoding parameters are based on the prompt or the LLM implemented by the APU. For example, the LLM is a target model to be used in speculative decoding, and the draft model is a smaller LLM of the same LLM family as the target model. As another example, the look ahead token length is determined based on number of the tokens that are generated based on the prompt at block 902. In some cases, the APU employs a neural network to output a set of SD parameters that the APU retrieves from a memory, such as memory 115 of FIG. 1. The neural network is trained to output sets of SD parameters to minimize a sum of runtimes during the one or more iterations of the process described with respect to blocks 904 to 908.

At block 906, the APU performs speculative decoding based on the SD parameters from block 904 and collects a runtime of the speculative decoding. For example, the APU performs speculative decoding based on the particular draft model and the particular look ahead token length output as SD parameters at block 904. The speculative decoding includes generating a set of look ahead tokens by a draft model based on the look ahead token length and the draft model selected as SD parameters at block 904. The speculative decoding also includes using a target model to check the look ahead tokens generated by the draft model and generating an additional token in a single pass through the target model. The target model then appends the confirmed look ahead tokens (if any) and the additional token to the one or more initial tokens from the prompt to generate an updated plurality of tokens.

At block 908, the APU compares the updated plurality of tokens to a maximum token length (e.g., an upper limit to an LLM output based on the prompt or an LLM character threshold). If the updated plurality of tokens is less than the maximum token length, then the method returns to block 904 to execute another iteration of blocks 904 to 908. If the updated plurality of tokens is at (or exceeds) the maximum token length, then the method proceeds to block 910 to generate the LLM output.

In some embodiments, the apparatus and techniques described above are implemented in a system including one or more integrated circuit (IC) devices (also referred to as integrated circuit packages or microchips), such as the APU described above with reference to FIGS. 1-9. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
generating a plurality of tokens from a prompt to a large language model (LLM);
in one or more iterations:
using a first neural network, outputting a set of speculative decoding parameters selected from a plurality of sets of speculative decoding parameters; and
performing speculative decoding using the set of speculative decoding parameters to generate a subsequent plurality of tokens appended to the plurality of tokens from the prompt or from a previous iteration to generate an updated plurality of tokens; and
collecting a runtime of the speculative decoding; and
repeating the one or more iterations until the updated plurality of tokens reaches a maximum token length,
wherein the first neural network is trained to output sets of speculative decoding parameters to minimize a sum of runtimes of the one or more iterations.

2. The method of claim 1, wherein the first neural network generates a probability distribution defined by the plurality of sets of speculative decoding parameters and selects the set of speculative decoding parameters based on the probability distribution.

3. The method of claim 1,
wherein a second neural network predicts a reward based on the runtime collected in the one or more iterations, wherein the reward is inversely proportional to or a negative multiple of the runtime.

4. The method of claim 3, wherein the second neural network is trained to maximize the reward.

5. The method of claim 1, wherein one speculative decoding parameter of the set speculative decoding parameters is a look ahead token length.

6. The method of claim 1, wherein one speculative decoding parameter of the set speculative decoding parameters is a size of a draft model.

7. The method of claim 6, wherein the size of the draft model is determined by selecting one draft model from a plurality of differently sized models of a common model family.

8. The method of claim 7, wherein the selected one draft model is smaller than a target model used in the speculative decoding, wherein the target model is one of the plurality of differently sized models of the common model family.

9. A processor configured to:
generate a plurality of tokens from a prompt to a large language model (LLM);
in one or more iterations:
using a first neural network, output a set of speculative decoding parameters selected from a plurality of sets of speculative decoding parameters; and
perform speculative decoding using the set of speculative decoding parameters to generate a subsequent set of tokens appended to the plurality of tokens based on the prompt or from a previous iteration to generate an updated plurality of tokens; and
collect a runtime of the speculative decoding; and
repeat the one or more iterations until the updated plurality of tokens reaches a maximum token length,
wherein the processor is configured to train the first neural network to output sets of speculative decoding parameters to minimize a sum of runtimes of the one or more iterations.

10. The processor of claim 9, wherein the processor implements the first neural network to generate a probability distribution defined by the plurality of sets of speculative decoding parameters, and wherein the processor is configured to select the set of speculative decoding parameters based on the probability distribution.

11. The processor of claim 9, wherein the processor implements a second neural network to predict a reward based on the runtime collected in the one or more iterations, wherein the reward is inversely proportional to or a negative multiple of the runtime.

12. The processor of claim 11, wherein the second neural network is trained to maximize the reward.

13. The processor of claim 9, wherein one speculative decoding parameter of the set of speculative decoding parameters is a look ahead token length.

14. The processor of claim 9, wherein one speculative decoding parameter of the set of speculative decoding parameters is a size of a draft model.

15. The processor of claim 14, wherein the size of the draft model is determined by selecting one draft model from a plurality of differently sized models of a common model family.

16. The processor of claim 15, wherein the selected one draft model is smaller than a target model used in the speculative decoding, wherein the target model is one of the plurality of differently sized models of the common model family.

17. A system comprising:
a memory configured to store a plurality of speculative decoding parameters;
a processor configured to, in one or more iterations:
retrieve, from the memory, a set of speculative decoding parameters from the plurality of speculative decoding parameters;
perform speculative decoding using the set of speculative decoding parameters to generate a subsequent set of tokens appended to a plurality of tokens generated from a prompt or from a previous iteration to generate an updated plurality of tokens; and
collect a runtime of the speculative decoding; and
repeat the one or more iterations until the updated plurality of tokens reaches a maximum token length,
wherein the processor is configured to implement a first neural network to retrieve sets of speculative decoding parameters from the memory to minimize a sum of runtimes of the one or more iterations.

18. The system of claim 17, the processor configured to implement a second neural network to predict a reward based on the runtime collected in the one or more iterations, wherein the reward is inversely proportional to or a negative multiple of the runtime, wherein the second neural network is trained to maximize the reward.

19. The system of claim 17, wherein one speculative decoding parameter of the set of speculative decoding parameters is a look ahead token length.

20. The system of claim 17, wherein one speculative decoding parameter of the set of speculative decoding parameters is a size of a draft model, wherein the size of the draft model is determined by selecting one draft model from a plurality of differently sized models of a common model family.
